(19) United States
(12) Patent Application Publication
(10) Pub. No.: US 2017/0201352 A1
(43) Pub. Date: Jul. 13, 2017

(54) PACKET HANDLING IN WIRELESS NETWORKS

(71) Applicant: TELEFONAKTIEBOLAGET LM ERICSSON (PUBL), Stockholm (SE)

(72) Inventors: Martin Hessler, Linköping (SE); Jonas Fröberg Olsson, Ljungsbro (SE); Olle Rosin, Linköping (SE); Erik Eriksson, Linköping (SE)

(21) Appl. No.: 15/314,997

(22) PCT Filed: Jun. 3, 2014
(86) PCT No.: PCT/EP2014/061443

§ 371 Date: Nov. 30, 2016

(51) Int. Cl. H04L 1/18; H04L 1/00

(52) U.S. Cl. CPC H04L 1/1841; H04L 1/0082; H04W 84/045

(57) ABSTRACT

There is provided packet handling in a client node between a hub node and a radio base station in a wireless network. A method performed by a client node comprises wirelessly receiving packets from a hub node. The packets are received in an order and being associated with an in-sequence order. A method performed by a client node comprises detecting that at least one packet of the packets is received out of said in-sequence order, and in response thereto providing an indicator indicating the in-sequence order. A method performed by a client node comprises providing the packets and the indicator to a radio base station.

### TECHNICAL FIELD

Embodiments presented herein relate to packet handling in a wireless network, and particularly to a method, a client node, a radio base station, computer programs, and a computer program product for packet handling in a wireless network.

### BACKGROUND

In communications networks, it may be challenging to obtain good performance and capacity for a given communications protocol, its parameters and the physical environment in which the communications network is deployed.

For example, increase in traffic within communications networks such as mobile broadband systems and an equally continuous increase in terms of the data rates requested by end-users accessing services provided by the communications networks may impact how cellular communications networks are deployed. One way of addressing this increase is to deploy lower-power network nodes, such as micro or pico radio bases station (RBS) network nodes (hereinafter denoted PBS), within the coverage area of a macro cell served by a macro base station (MBS) network node. Examples where such additional network nodes may be deployed are scenarios where end-users are highly clustered. Examples where end-users may be highly clustered include, but are not limited to, around a square, in a shopping mall, or along a road in a rural area. Such a deployment of additional network nodes is referred to as a heterogeneous or multi-layered network deployment, where the underlying layer of low-power micro or PBS network nodes does not need to provide full-area coverage. Rather, low-power network nodes may be deployed to increase capacity and achievable data rates where needed. Outside of the micro- or PBS-layer coverage, end-users would access the communications network by means of the overlaid macro cell.

Backhauling based on the Long Term Evolution (LTE) telecommunications standards may be carried either over normal IMT-bands, e.g. the 2.6 GHz frequency band, or by running LTE baseband communications on higher radio frequencies, such as in the 28 GHz frequency band. LTE based backhauling implies that the PBS network nodes are connected to a client node which is used to create a wireless link to a hub node.

In any of the above two cases, the wireless links are typically managed by LTE core control mechanisms. For example, the LTE Mobility Management Entity (MME) may be utilized for session control of the LTE links, and the Home Subscription Service (HSS) may be utilized for storing security and Quality of Service (QoS) characteristics of the wireless links of individual wireless end-user terminals embedded in the PBS network node.

Moreover, in practice more than one client node may connect to a common hub node. This implies support for Radio Resource Management (RRM) functions, such as scheduling and prioritization of the traffic to and from the different clients, at the hub node.

To each client node there might be several PBS network nodes, each of which may offer one or several different radio access technologies, such as based on the Universal Mobile Telecommunications System (UMTS), LTE, or IEEE 802.11x to the wireless end-user terminals of the end-users. Therefore there is a need to differentiate between the corresponding backhaul traffic to different nodes in the communications network. For example, any LTE compliant traffic may need to end up in nodes such as the serving gateway (SGW) or the MME and any WiFi compliant traffic may end up in an edge router or an Evolved Packet Data Gateway (ePDG).

Moreover, for a given radio access technology (RAT), QoS differentiation is provided to the end-users (i.e., to the wireless end-user terminals of the end-users) so that e.g. guaranteed bitrate (GBR) services, such as voice calls, will not be disturbed by best effort (BE) services, such as web browsing. In order [symbol] is, QoS differentiation is needed also on the backhaul links.

If the wireless backhaul is based on LTE, there are tools that provide both the routing functions and QoS differentiation, such as based on the LTE bearer concept. Typically then, for each type of RAT, one GBR and one BE bearer are established on the backhaul links. Different frameworks may be used to prioritize between different traffic, for example to determine if 10 kbit/s Voice over Internet protocol (VoIP) data to/from one wireless end-user terminal is more or less prioritized than 10 Mbit/s web-surfing data to/from another wireless end-user terminal. The aggregated VoIP traffic for one RAT may be in the order of 10 Mbit/s. The aggregated web-surfing data traffic for one RAT may be in the order of 100 Mbit/s.

Known ways for backhauling, such as disclosed in US 2011/0194535, may dynamically configure backhaul bearers based on the end-user bearers that are multiplexed into the backhauls bearers.

FIG. 11 schematically illustrates protocol stacks used at different network entities when the backhaul is based on LTE. FIG. 11 schematically illustrates how the Internet Protocol (IP), Ethernet (Eth), general packet radio service tunneling protocol user plane (GTP-U), user datagram protocol (UDP), packet data convergence protocol (PDCP), radio link control (RLC), medium access control (MAC), and physical layer (PHY) interact and are used.

In the example illustration of FIG. 11 a user application of a wireless terminal 11a is operatively connected to an application server (App server) 110 via a radio base station 13a, a client node 17a, hub node 10a, a serving gateway for the backhaul (S-GW-BH) 112, and a serving gateway for the core network (S-GW) 114. FIG. 11 illustrates only the protocol stacks for the user plane traffic and only a part of the entities involved in the user plane processing. The user traffic is serviced by a “bearer” between the Packet Data Network Gateway (PDN-GW; not shown in FIG. 11), which is the access point towards the LTE network, and the wireless terminal 11a. The traffic forwarding between the PDN-GW and the S-GW is out of the scope of the current disclosure.

As can be noted in FIG. 11 the tunneling endpoint for the user traffic is at the radio base station 13a and hence the IP packets of the wireless terminal 11a will be carried by GTP-user plane (GTP-U) which in turn are encapsulated in the UDP and yet another IP packet. All three encapsulating protocols are terminated in the client node 17a/radio base station (in the accompanying figures denoted pico radio base station, PBS) 13a and will thus be carried to the wireless terminal 11a by the Radio Access Bearer (RAB) between the hub node 10a and client node 17a/radio base station 13a.

For such a wireless backhaul link one or a low number of bearers will transport most of the traffic, for example, the best effort bearer would in many cases have the majority of the traffic. These bearers will map to a PDCP/RLC instance. For a LTE based wireless backhaul network the wireless backhaul link may typically run in an RLC acknowledged mode. This may imply that most of the backhaul traffic shares the same RLC segmentation and in-sequence delivery.

In general terms, it may reasonably be assumed that in any wireless link there will be errors in the transmission. In LTE this will result in a hybrid automatic repeat request (HARQ) re-transmission, or even worse an RLC retransmission for the RLC acknowledge mode. Such re-transmissions may typically occur around 8 ms later for a HARQ re-transmission. This implies that the RLC in the client node could potentially buffer data from all the 7 Transmission Time Intervals (TTIs) in-between before being able to deliver the data in-order to the connected PBS. This further implies that the TTIs in-between will be more or less empty in the PBS, which can significantly reduce the average throughput in the PBS when the downlink in the PBS is under-utilized. The under-utilization during some TTIs may also result in over-utilization in other TTIs, making the issue even more severe.

Hence, there is still a need for an improved packet handling in a wireless network, such as in a wireless backhaul network.

### SUMMARY

An object of embodiments herein is to provide improved packet handling in a wireless network, such as in a wireless backhaul network.

According to a first aspect there is presented a method for packet handling in a client node between a hub node and a radio base station in a wireless network. The method is performed by the client node. The method comprises wirelessly receiving packets from a hub node, the packets being received in an order and being associated with an in-sequence order. The method comprises detecting that at least one packet of the packets is received out of the in-sequence order, and in response thereto providing an indicator indicating the in-sequence order. The method comprises providing the packets and the indicator to a radio base station.

Advantageously this provides efficient packet handling in a wireless network, such as in a wireless backhaul network.

This enables increased system throughput when multiple wireless links are connected in series using a re-transmission protocol using sequence numbers, such as RLC, e.g. a LTE based backhaul link connecting to a LTE PBS whilst maintaining compatibility with legacy wireless end-user terminals and maintaining re-transmission and in sequence delivery to the application layer of the wireless end-user terminal.

The packets may be provided in a particular order. For example, the packets may be provided in a predetermined order or in an arbitrary order. For example, the packets may be provided in the order in which the packets were received by the client node.

According to a second aspect there is presented a client node for packet handling in a client node between a hub node and a radio base station in a wireless network. The client node comprises a processing unit. The processing unit is configured to cause the client node to wirelessly receive packets from a hub node, the packets being received in an order and being associated with an in-sequence order. The processing unit is configured to cause the client node to detect that at least one packet of said packets is received out of the in-sequence order, and in response thereto providing an indicator indicating the in-sequence order. The processing unit is configured to cause the client node to provide the packets and the indicator to a radio base station.

According to a third aspect there is presented a computer program for packet handling in a client node between a hub node and a radio base station in a wireless network, the computer program comprising computer program code which, when run on a processing unit, causes the client node to perform a method according to the first aspect.

According to a fourth aspect there is presented a method for packet handling in a radio base station between a client node and a wireless terminal device in a wireless network. The method is performed by the radio base station. The method comprises receiving packets and an indicator from a client node, the packets being received in an order and being associated with an in-sequence order as indicated by the indicator. The method comprises detecting that at least one of the packets is received out of the in-sequence order based on the indicator, and in response thereto providing a further indicator enabling restoration of the in-sequence order. The method comprises wirelessly transmitting the packets and the further indicator to a wireless terminal device.

The packets may be transmitted in a particular order. For example, the packets may be transmitted in a predetermined order or in an arbitrary order. For example, the packets may be transmitted in the order in which the packets were received by the PBS 13a.

According to a fifth aspect there is presented a radio base station for packet handling in a radio base station between a client node and a wireless terminal device in a wireless network. The radio base station comprises a processing [symbol] processing unit is configured to cause the radio base station to receive packets and an indicator from a client node, the packets being received in an order and being associated with an in-sequence order as indicated by the indicator. The processing unit is configured to cause the radio base station to detect that at least one of the packets is received out of the in-sequence order based on the indicator, and in response thereto providing a further indicator enabling restoration of the in-sequence order. The processing unit is configured to cause the radio base station to wirelessly transmit the packets and the further indicator to a wireless terminal device.

According to a sixth aspect there is presented a computer program for packet handling in a radio base station between a client node and a wireless terminal device in a wireless network, the computer program comprising computer program code which, when run on a processing unit, causes the radio base station to perform a method according to the fourth aspect.

According to a seventh aspect there is presented a computer program product comprising a computer program according to at least one of the third aspect and the fourth aspect, and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1a and 1b are schematic diagrams illustrating a communications network according to embodiments;

FIG. 2a is a schematic diagram showing functional units of a client node according to an embodiment;

FIG. 2b is a schematic diagram showing functional modules of a client node according to an embodiment;

FIG. 3a is a schematic diagram showing functional units of a radio bases station according to an embodiment;

FIG. 3b is a schematic diagram showing functional modules of a radio bases station according to an embodiment;

FIG. 4 shows one example of a computer program product comprising computer readable means according to an embodiment;

FIGS. 5, 6, 7, and 8 are flowcharts of methods according to embodiments;

FIG. 9 schematically illustrates an overview of fields in the GPRS tunneling protocol;

FIG. 10 schematically illustrates packet handling in a wireless network; and

FIGS. 11, 12, and 13 schematically illustrate protocol stacks according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

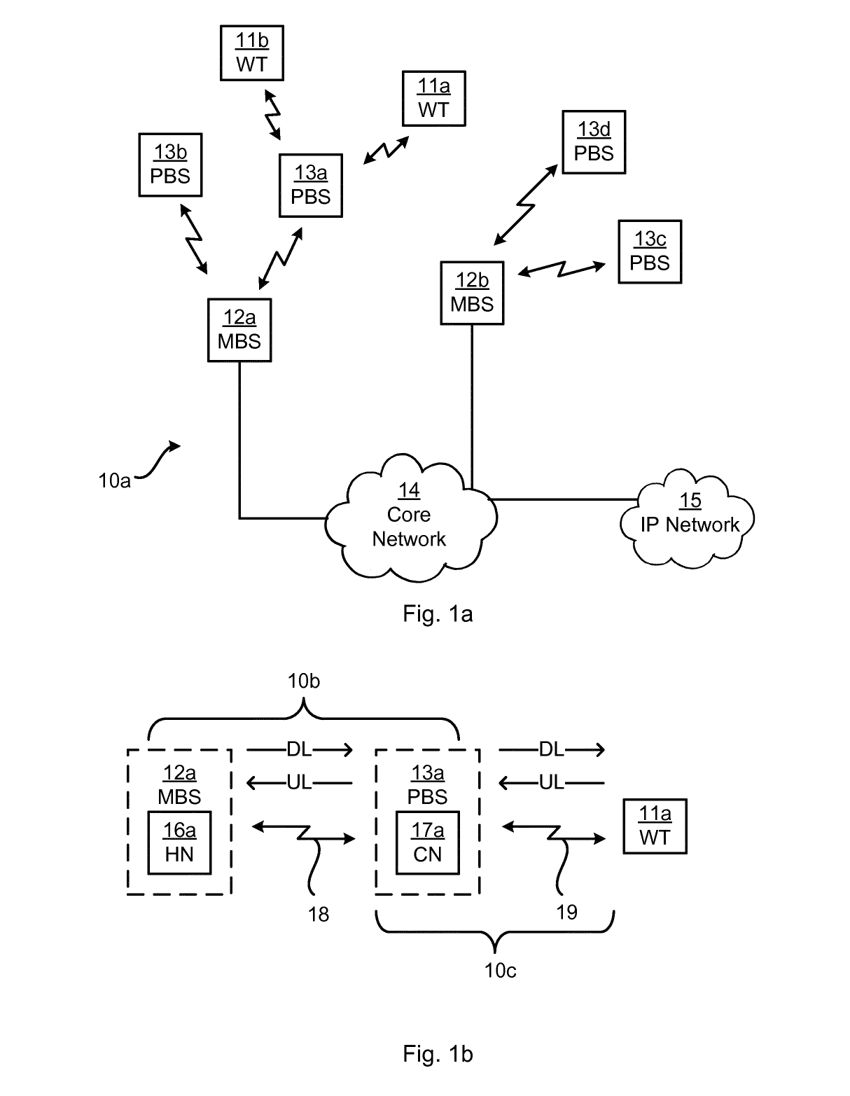

FIG. 1a is a schematic diagram illustrating a communications network 10a where embodiments presented herein can be applied. The communications network 10a comprises macro radio base stations (MBS) 12a, 12b providing wireless backhaul to pico radio base stations (PBS) 13a, 13b, 13c, 13d. The macro radio base stations 12a-b are operatively connected to a core network 14 which in turn is operatively connected to a service providing Internet Protocol based network 15. A wireless end-user terminal (WT) 11a, 11b served by a pico radio base station 13a-d is thereby able to access services and data provided by the IP network 15. The wireless end-user terminals 11a, 11b have a wireless connection to the pico radio base stations 13a-d. The pico radio base stations 13a-d and their respective links towards served wireless end-user terminals 11a, 11b define an end-user access network 10c (see, FIG. 1b). The pico radio base stations 13a-d may provide one or a combination of several radio access technologies over its radio access links, e.g. 3GPP LTE, 3GPP HSPA (high speed packet access), 3GPP GSM (global system for mobile communications) or IEEE 802.11x (WiFi). Additionally, the pico radio base stations 13a-d may have one or more wired interfaces towards the wireless end-user terminals 11a, 11b. Each pico radio base station 13a-d needs to backhaul the end-user access network traffic and uses a wireless link towards a macro radio base station 12a-b for this purpose.

The pico radio base stations 13a-d may be backhauled by means of “client nodes” (CN) and “hub nodes” (HN). In general terms, the client node and the hub node are logical entities. The client node establishes a backhaul connection to the core network via the hub node. In case of a wireless backhaul, the term “client node” thus denotes the unit (or subunit within a micro or pico radio base station) that connects the micro or pico radio base station 13a-d to the hub node. The hub node denotes the other end (with respect to the client node) of the wireless backhaul link where the wireless backhaul continues over a wired or wireless connection to the core network.

FIG. 1b is a schematic diagram illustrating a communications network where embodiments presented herein can be applied. The communications network of FIG. 1b comprises a macro radio base station (MBS) 12a and a pico radio base station (PBS) 13a. FIG. 1b further schematically illustrates a wireless backhaul network 10b and an end-user access network 10c. In the end-user access network 10c a wireless end-user terminal (WT) 11a is served by the pico radio base station 13a over a wireless link 19. In the wireless backhaul network 10b the macro radio base station 12a provides wireless backhaul over a wireless link 18 to the pico radio base station 13a. As illustrated in FIG. 1b, a hub node 16a may be co-located with a macro radio base station 12a and a client node 17a may be co-located with a pico radio base station 13a. Hence, the hub node 16a may be implemented in a macro radio base station, and the client node 17a may be implemented in a micro radio base station or a pico radio base station 13a. However, the pico radio base station 13a-d and client node 17a do not have to be co-located. The same applies for the hub node 16a and the macro radio base station 12a-b.

For example, in the communications network described above the downlink to the wireless end-user terminal 11a, 11b may experience interruptions in the data transmission, leading to durations when no or very little end-user data is transmitted over the wireless links 18, 19. Not only is this bad for the throughput of the PBS 13a but this will also inject erratic changes in end-user latency and also interference when the PBS 13a switches between being more or less silent when waiting for backhaul data and transmitting at full power when data is available. The embodiments disclosed herein relate to packet handling in a wireless network 10a, 10b, 10c. In order to obtain such packet handling there is provided a client node 17a, a method performed by the client node 17a, a computer program comprising code, for example in the form of a computer program product, that when run on a processing unit, causes the processing unit to perform the method of the client node 17a. In order to obtain such packet handling there is also provided a radio base station 13a, a method performed by the radio bases station 13a, a computer program comprising code, for example in the form of a computer program product, that when run on a processing unit, causes the processing unit to perform the method of the radio bases station 13a.

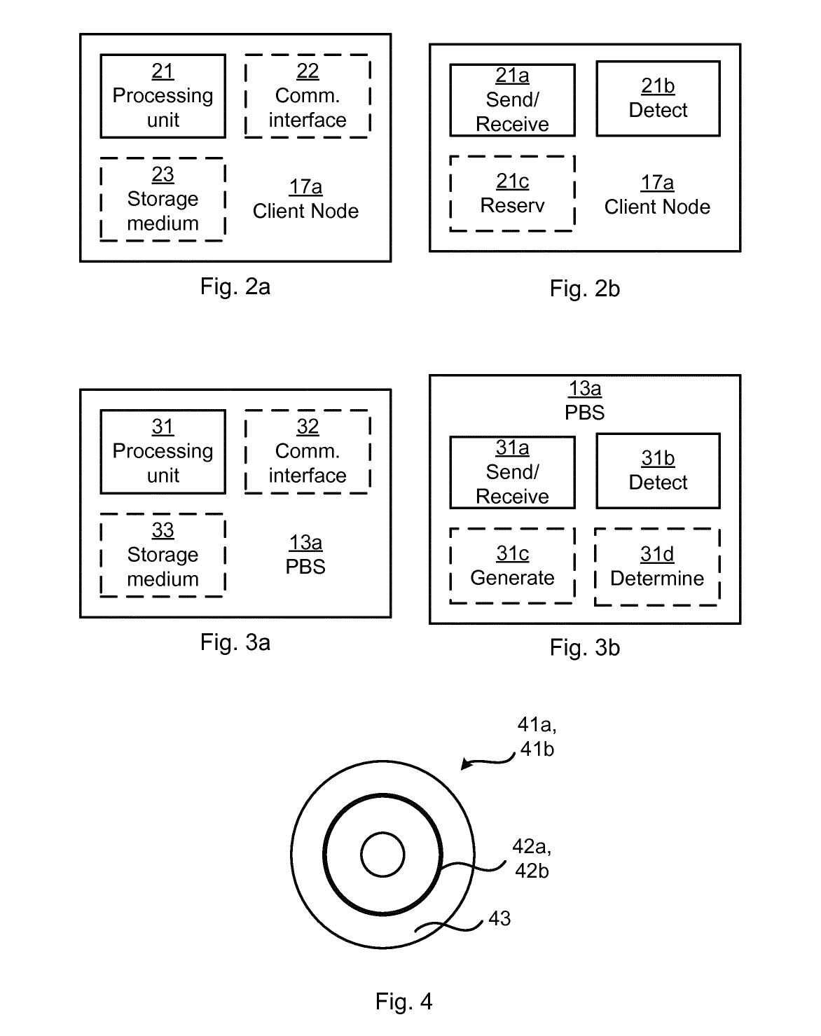

FIG. 2a schematically illustrates, in terms of a number of functional units, the components of a client node 17a according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41a (as in FIG. 4), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The client node 17a may further comprise a communications interface 22 for communications with any of at least one hub node 16a and at least one radio bases station 13a. As such the communications interface 22 may comprise one or more transmitters and receivers, comprising analogue and digital components and a suitable number of antennas for radio communications and/or interfaces for wired communications. The processing unit 21 controls the general operation of the client node 17a e.g. by sending data and control signals to the communications interface 22 and the storage medium 23, by receiving data and reports from the communications interface 22, and by retrieving data and instructions from the storage medium 23. Other components, as well as the related functionality, of the client node 17a are omitted in order not to obscure the concepts presented herein.

FIG. 2b schematically illustrates, in terms of a number of functional modules, the components of a client node 17a according to an embodiment. The client node 17a of FIG. 2b comprises a number of functional modules; a send/receive module 21a, and a detect module 21b. The client node 17a of FIG. 2b may further comprise a number of optional functional units, such as reserve 21c. The functionality of each functional module 21a-c will be further disclosed below in the context of which the functional units may be used. In general terms, each functional module 21a-c may be implemented in hardware or in software. The processing unit 21 may thus be arranged to from the storage medium 23 fetch instructions as provided by a functional module 21a-c and to execute these instructions, thereby performing any steps as will be disclosed hereinafter.

The client node 17a may be provided as a standalone device or as a part of a further device. For example, the client node 17a may be provided as part of a radio base station 13a, such as an evolved Node B. The client node 17a may be co-located with a radio resource management (RRM) functionality. The client node 17a may be provided as an integral part of the radio base station 13a. That is, the components of the client node 17a may be integrated with other components of the radio base station 13a; some components of the radio base station 13a and the client node 17a may be shared. For example, if the radio base station 13a as such comprises a processing unit, this processing unit may be arranged to perform the actions of the processing unit 21 of the client node 17a. Alternatively the client node 17a may be provided as a separate unit in the radio base station 13a.

FIG. 3a schematically illustrates, in terms of a number of functional units, the components of a radio bases station 13a according to an embodiment. A processing unit 31 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41b (as in FIG. 4), e.g. in the form of a storage medium 33. Thus the processing unit 31 is thereby arranged to execute methods as herein disclosed. The storage medium 33 may also comprise persistent storage, which, for example, can be any single one or combination of magnetic memory, optical memory, solid state memory or even remotely mounted memory. The radio bases station 13a may further comprise a communications interface 32 for communications with any of at least one client node 17a and at least one wireless end-user terminal 11a, 11b. As such the communications interface 32 may comprise one or more transmitters and receivers, comprising analogue and digital components and a suitable number of antennas for radio communications and/or interfaces for wired communications. The processing unit 31 controls the general operation of the radio bases station 13a e.g. by sending data and control signals to the communications interface 32 and the storage medium 33, by receiving data and reports from the communications interface 32, and by retrieving data and instructions from the storage medium 33. Other components, as well as the related functionality, of the radio bases station 13a are omitted in order not to obscure the concepts presented herein.

FIG. 3b schematically illustrates, in terms of a number of functional modules, the components of a radio bases station 13a according to an embodiment. The radio bases station 13a of FIG. 3b comprises a number of functional modules; a send/receive module 31a, and a detect module 31b. The radio bases station 13a of FIG. 3b may further comprises a number of optional functional units, such as any of a generate module 31c and a determine module 31d. The functionality of each functional module 31a-d will be further disclosed below in the context of which the functional units may be used. In general terms, each functional module 31a-d may be implemented in hardware or in software. The processing unit 31 may thus be arranged to from the storage medium 33 fetch instructions as provided by a functional module 31a-d and to execute these instructions, thereby performing any steps as will be disclosed hereinafter.

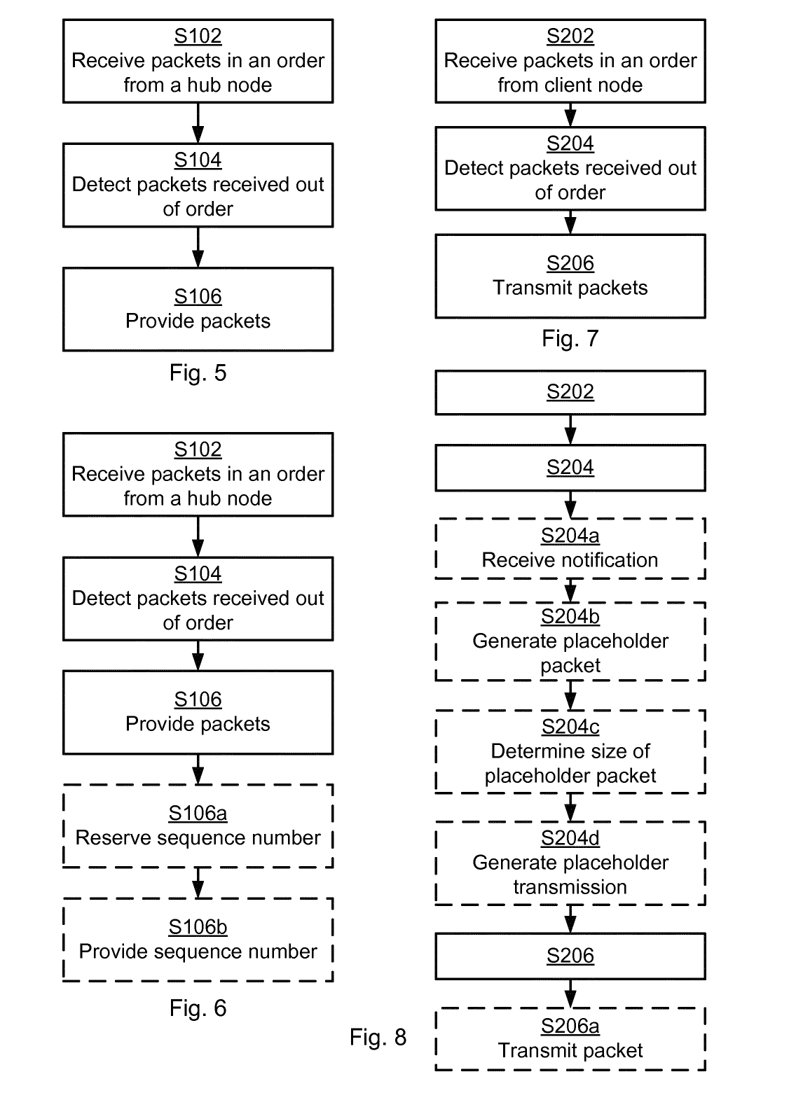

FIGS. 5 and 6 are flow charts illustrating embodiments of methods for packet handling in a client node 17a between a hub node 16a and a radio base station 13a in a wireless network 10a, 10b, 10c as performed by the client node 17a. FIGS. 7 and 8 are flow charts illustrating embodiments of methods for packet handling in a radio base station 13a between a client node 17a and a wireless terminal device 11a in a wireless network 10a, 10b, 10c as performed by the radio base station 13a. The methods are advantageously provided as computer programs 42a, 42b. FIG. 4 shows one example of a computer program product 41a, 41b comprising computer readable means 43. On this computer readable means 43, at least one computer program 42a, 42b can be stored, which computer program 42a can cause the processing unit 21 and thereto operatively coupled entities and devices, such as the communications interface 22 and the storage medium 23 to execute methods according to embodiments described herein, and which computer program 42b can cause the processing unit 31 and thereto operatively coupled entities and devices, such as the communications interface 32 and the storage medium 33 to execute methods according to embodiments described herein. The at least one computer program 42a, 42b and/or computer program product 41a, 41b may thus provide means for performing any steps as herein disclosed.

In the example of FIG. 4, the computer program product 41a, 41b is illustrated as an optical disc, such as a CD (compact disc) or a DVD (digital versatile disc) or a Blu-Ray disc. The computer program product 41a, 41b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the at least one computer program 42a, 42b is here schematically shown as a track on the depicted optical disk, the at least one computer program 42a, 42b can be stored in any way which is suitable for the computer program product 41a, 41b.

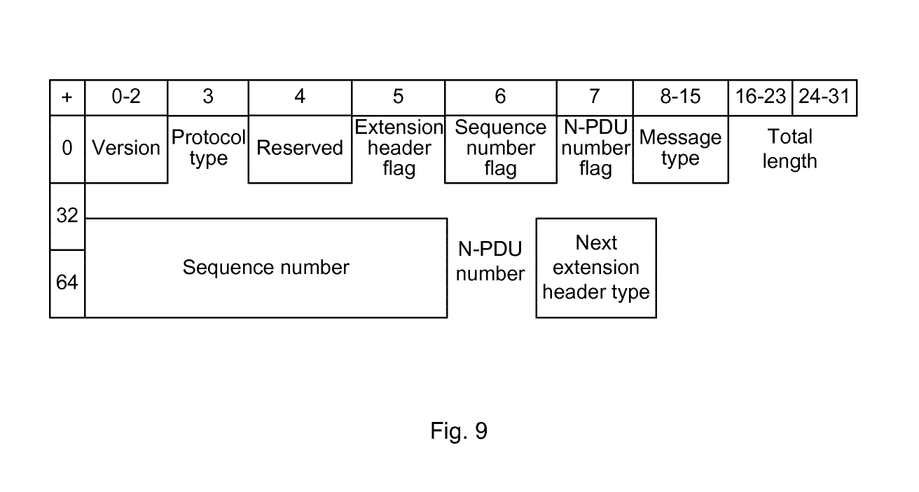

Some of the herein disclosed embodiments are based on the usage of the general packet radio service tunneling protocol (GTP). In FIG. 9 the fields of GTP v1 are depicted; a version field, a protocol field, a reserved field, a sequence number flag field, an N-PDU number flag field, a message type field, a total length field, a sequence number field, an N-PDU number field, and a next extension header type field. The same or similar fields are also present in GTP v2. It may be assumed that GTP v2 also contains all relevant fields, e.g. TEID, that is, typically the TEID indicator flag is set to 1 (true) for GTP v2. GTP v1 and GTP v2 are as such known in the art and further description thereof is therefore omitted.

Reference is now made to FIG. 5 illustrating a method for packet handling in a client node 17a between a hub node 16a and a radio base station 13a in a wireless backhaul network 10a, 10b, 10c according to an embodiment. The method is performed by the client node 17a.

The method comprises a step S102 of wirelessly receiving packets from a hub node 16a. The packets are received in an order and are associated with an in-sequence order. The in-sequence order does not necessarily correspond to the order in which the packets are received. The method therefore comprises a step S104 of detecting that at least one packet of the packets is received out of the in-sequence order. In response thereto an indicator indicating the in-sequence order is provided. The packets may then be transmitted from the client node 17a. The method thus comprises a step S106 of providing the packets and the indicator to a radio base station (denoted PBS, 13a).

The packets may in step S106 be provided in a particular order. For example, the packets may be provided in a predetermined order or in an arbitrary order. For example, the packets may in step S106 be provided in the order in which the packets were received in step S102 by the client node 17a.

Reference is now made to FIG. 6 illustrating methods for packet handling in a client node 17a between a hub node 16a and a radio base station 13a in a wireless backhaul network 10a, 10b, 10c according to further embodiments.

The indicator may be a sequence number, and one sequence number may be provided in each packet. Detecting that the at least one of the packets is received out of the in-sequence order in step S104 may then be based on detecting a missing sequence number in the received packets.

Providing the indicator indicating the in-sequence order in step S104 may comprise an optional step S106a of reserving one sequence number for each at least one packet received out of the in-sequence order; and in an optional step S106b providing the one sequence number to the at least one packet upon its reception.

The packets may in step S102 be received and/or in step S106 be provided using a re-transmission protocol using sequence numbers. The packets from the hub node 16a may be wirelessly received in a radio link control (RLC) instance. Each packet may be a protocol data unit (PDU). Each PDU may comprise at least one service data unit (SDU). The number of packets from the hub node 16a does not need to match the number of packets transmitted to the WT 11a. Hence, each received PDU may comprise a different number of SDUs than each provided PDU.

Reference is now made to FIG. 7 illustrating a method for packet handling in a radio base station 13a between a client node 17a and a wireless terminal device 11a in a wireless backhaul network 10a, 10b, 10c according to an embodiment. The method is performed by the PBS 13a.

The method comprises a step S202 of receiving packets and an indicator from a client node 17a. The packets are received in an order and are associated with an in-sequence order as indicated by the indicator. The in-sequence order does not necessarily correspond to the order in which the packets are received. The method therefore comprises a step S204 of detecting that at least one of the packets is received out of the in-sequence order based on the indicator. In response thereto a further indicator enabling restoration of the in-sequence order is provided. The packets may then be transmitted from the PBS. The method thus comprises a step S206 of wirelessly transmitting the packets and the further indicator to a wireless terminal device 11a.

The packets may in step S206 be transmitted in a particular order. For example, the packets may be transmitted in a predetermined order or in an arbitrary order. For example, the packets may in step S206 be transmitted in the order in which the packets were received in step S202 by the PBS 13a.

Reference is now made to FIG. 8 illustrating methods for packet handling in a radio base station 13a between a client node 17a and a wireless terminal device 11a in a wireless backhaul network 10a, 10b, 10c according to further embodiments.

The indicator may be a sequence number, and one sequence number may be provided in each received packet. The further indicator may be provided by means of a placeholder (or “imaginary” packet. Particularly, the further indicator may be provided by in an optional step S204b, generating at least one placeholder packet representing the at least one packet received out of the in-sequence order. In an optional step S204d a placeholder transmission (i.e., an “imaginary” transmission) of the at least one placeholder packet may then be generated. The method may then further comprise in an optional step S206a wirelessly transmitting the at least one packet received out of the in-sequence order once received by the PBS 13a, and in response thereto marking the at least one placeholder packet as transmitted. Additionally or alternatively the further indicator may be provided as at least one sequence number reservation.

The packets may in step S202 be received and/or in step S206 be transmitted using a re-transmission protocol using sequence numbers. Detecting that the at least one of the packets is received out of the in-sequence order in step S204 may be based on detecting a missing sequence number in the received packets. The packets to the end-user terminal device 11a may be wirelessly transmitted in an RLC instance. Each packet may be a protocol data unit (PDU). Each PDU may comprise at least one service data unit (SDU). As noted above, the number of packets from the hub node 16a does not need to match the number of packets transmitted to the WT 11a. Hence, each received PDU may comprise a different number of SDUs than each transmitted PDU.

In some embodiments, the RLC of the client node 17a is an ordinary RLC except that RLC SDUs are delivered out of order. In such embodiments the terminating GTP-U entity detects missing GTP-U packages using the sequence numbers according to the above method. Upon detection of one or more packages the terminating GTP-U instance injects/notifies the PDCP of the PBS 13a about placeholder SDUs. The PDCP instance of the PBS 13a in turn allocates PDCP sequence numbers for the corresponding (placeholder) PDCP PDUs. When the RLC of the PBS 13a shall build a RLC PDU it requests information from the PDCP instance about size and number of PDCP PDUs ready for transmission and about number of placeholder PDCP PDUs (i.e., data not arrived yet).

Assume that the available PDCP PDUs that are ready to be transmitted have the set of sequence numbers according to the following illustrative, non-limiting, example: {M, M+1, . . . , M+P−1, M+Q, M+Q+1, . . . , M+N}, where Q>P, while the placeholder PDCP PDUs have set of sequence numbers as follows: {M+P, M+P+1, . . . , M+Q−1}. Hence, according to the present example there is a “hole” (defined by missing PDCP PDUs) in the sequence of PDCP PDUs ready to be transmitted. The RLC of the PBS 13a may use one or more RLC PDUs for the transmission of the PDCP PDUs M, . . . , M+P−1 using the RLC sequence numbers N, N+1, . . . , N+R. The RLC of the PBS 13a may also use one or more RLC PDUs containing the PDCP PDUs M+Q, M+Q+1, . . . , M+N, but then it needs to use RLC sequence numbers being at least N+R+2 in order to later be able to assign N+R+1 for RLC PDU for the currently unavailable data; otherwise in-order delivery cannot be preserved at the WT 11a.

In some embodiments the underlying architecture of the backhaul links is assumed to be agnostic to the connected end-user solution. In such embodiments one assumption is that the herein disclosed embodiments are implemented for the end-user technologies that have a compatible RLC implementation, e.g. a LTE PBS 13a. Hence for these embodiments the backhaul network is assumed to be a regular LTE implementation without removing anything in its protocol stack.

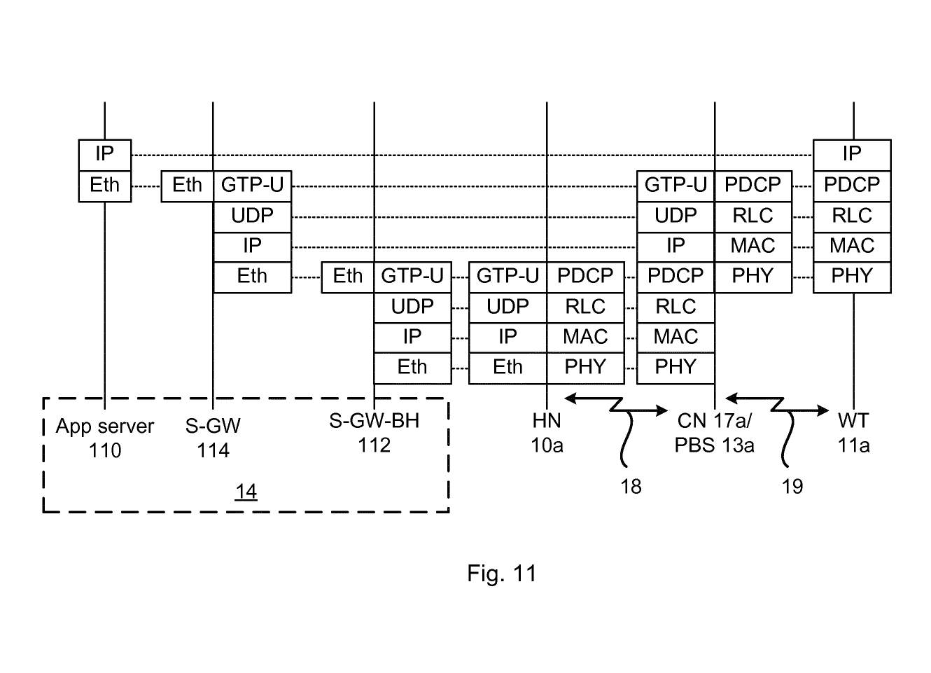

In such embodiments the PBS 13a is operatively connected to one core network 14. The hub node 16a may be operatively connected to one core network 14. The core network of the PBS 13a and the core network of the hub node 16a may be different or the same. In the example of FIG. 11 the protocol stacks are shown for the network nodes involved in the functionality affected by the herein disclosed embodiments. Additional network nodes in the core network are typically involved in the data transport but are explicitly illustrated in FIG. 11.

FIG. 11 illustrates an example of how the protocol stacks may be implemented for some of the herein disclosed embodiments assuming LTE end-user access. Tunneling between the S-GW 114 and the PBS 13a utilizes GTP-U. Further, these GTP-U instances map to a potentially limited set of GTP-U tunnels between the S-GW-BH 112 and the hub node 16a in the core network of the backhaul network. As disclosed above, this leads to issues when the wireless link between the hub node 16a and the client node 17a encounters an error. Such issues may be remedied by applying methods according to embodiments as herein disclosed.

Hence, assume, for illustrative purposes, that there is one or a number of missing transmissions between the hub node 16a and the client node 17a. This situation may be remedied by implementing the herein disclosed enhanced RLC functionality in the connected PBS 13a.

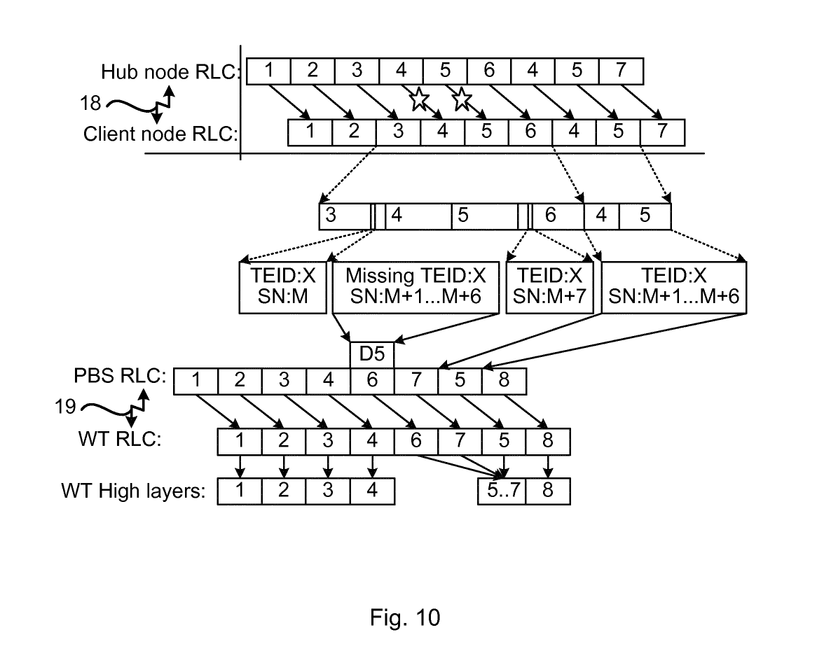

According to the present embodiment the particular TEID=X is for the PBS 13a core network and bearer. That is TEID_{UE}=X related to the GTP-U header used for tunneling data between the S-GW and the PBS 13a for the considered WT 11a and bearer with the TEID_{UE}=X. In this embodiment this particular TEID_{UE} will then also map to a particular RLC for the hub node-client node wireless link 18. This RLC pair then corresponds to some other TEID for the backhaul network, i.e. TEID_{BH}=Y which is used to tunnel data received in the S-GW of the backhaul network to the correct client node 17a and bearer corresponding to the hub node 16a and client node 17a RLC pair in FIG. 10, see below.

In general terms, missing GTP-U PDUs may be used to estimate the amount of missing data. There are many suitable methods that can be used for this estimation. In some embodiments the historic average GTP-U segment size or the average of the last segment before and the first after the transmission error are used for this estimation, possibly excluding the GTP header. A size of the at least one placeholder packet may thus be determined, in an optional step S204c, for example based on at least one of a historic average of previously received packets, a maximum allowable packet size, a minimum allowable packet size, and information received from the client node.

Additionally or alternatively, a notification may in an optional step S204a be received from the client node 17a about the at least one packet being received out of the in-sequence order. The at least one placeholder packet may be generated in response thereto. The size can also be signaled between the involved network nodes. That is, a RLC coordination node may signal the sizes to use to the involved network nodes. When the signaled sizes are known in the estimation step for the missing GTP-U segments the estimation will thus typically be perfect. The signaling may be infrequent, so even with coordination, sometimes the GTP-U segment size could have changed and the estimation thus becomes wrong, but this would typically occur much less frequently with signaling. If the segment size estimation is wrong, this is in principal not an issue since RLC supports re-segmentation, thus enabling the estimation error to be corrected with some additional overhead. The maximum RLC PDU size is limited by the 15 bit SO field in the re-segmentation header. The SO field points out the position in the original RLC PDU where the re-segmented data starts. If the placeholder packet estimated size is larger than 2̂ 15 the result could be a re-segment requiring an SO larger than 2̂ 15, which is not allowed. Thus the maximum size of a placeholder packet should be 2̂ 15. The number of placeholder packets can be calculated as: (estimated size+2̂ 15−1)/2̂ 15.

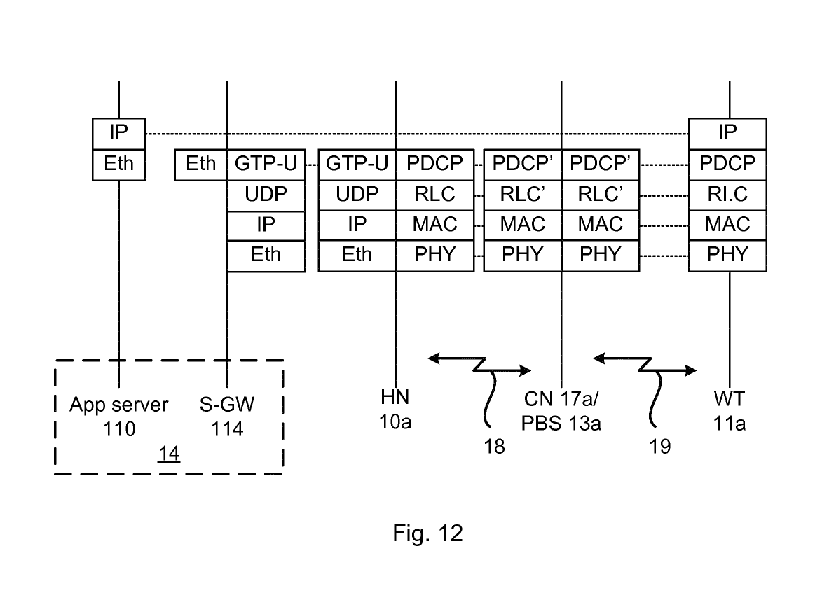

In some embodiments the GTP-U (top-most GTP—U layer in FIG. 11) protocol is terminated in the hub node 16a. This will reduce the load on the wireless link between the hub node 16a and the client node 17a/PBS 13a due to that the GTP-U header is not sent over air. FIG. 12 provides an illustration of protocol stacks where the GTP-U associated with the WT 11a is terminated in the hub node 16a. In FIG. 12 all instances of the notation “'” indicate that protocol changes are needed for the herein disclosed embodiments to apply. Thus, the at least one packet being received out of said in-sequence order in steps S102 may be detected at a packet data convergence protocol (PDCP) peer level at the client node 17a. The at least one packet being received out of the in-sequence order in step S202 may be detected at a packet data convergence protocol (PDCP) peer level at the PBS 13a. In the considered embodiments it is thus the receiving PDCP entity of the first wireless link that detects missing PDUs/SDUs. Hence, in considered embodiments the receiving PDCP entity detects missing PDSs/SDUs and upon detection of missing PDUs/SDUs injects placeholder PDUs/SDUs to the sending PDCP entity of the second wireless link or notifies the sending PDCP entity about the missing (delayed) SDUs. In some embodiments PDCP is terminated in the client node 17a/PBS 13a wherein the receiving PDCP entity injects placeholder SDUs, or notifies the sending PDCP about missing (delayed) SDUs.

In other embodiments, PDCP is not terminated and the receiving PDCP entity just forwards the received PDUs to sending PDCP entity. That placeholder PDCP PDUs is needed can be detected by either the receiving PDCP entity of first wireless link or sending PDCP entity of second wireless link.

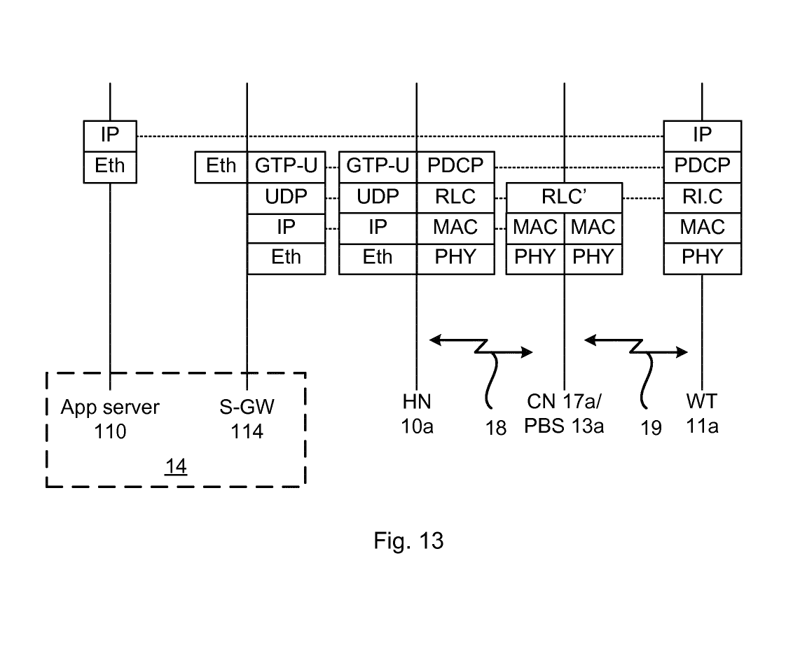

In some embodiments where GTP-U is terminated in the hub node 16a, the RLC may be responsible of detecting missing/delayed PDUs/SDUs. For example, PDCP sequence numbers may not be used to detect missing PDUs/SDUs. The protocol stacks in such embodiments is illustrated in FIG. 13. FIG. 13 is an illustration of protocol stacks where the GTP-U associated with the WT 11a is terminated in the HUB and PDCP is not terminated in each wireless “jump”. In FIG. 13 all instances of the notation “'” indicate that protocol changes are needed for the herein disclosed embodiments to apply. The RLC layer in client node 17a/PBS 13a is drawn as one “box” since protocol-wise the receiving RLC in client node 17a/PBS 13a may not terminate the protocol. However, still the RLC layer contains two receiving and two sending entities, i.e. one receiving entity for each first and second wireless link 18, 19 and one sending entity for each first and second wireless link 18, 19. Thus, the at least one packet being received out of said in-sequence order in steps S102 may be detected at a radio link control (RLC) protocol peer level at the client node 17a. The at least one packet being received out of the in-sequence order in step S202 may be detected at a radio link control (RLC) protocol peer level at the PBS 13a.

In some embodiments, the RLC in the client node 17a/PBS 13a detects missing RLC PDUs and handles status reporting to RLC in the hub node 16a. When the RLC in the client node 17a/PBS 13a detects a missing RLC PDU it sends a status report to the RLC in the hub node 16a which in turn triggers a re-transmission of the missing RLC PDU. RLC PDUs received over first wireless link can be sent directly over the second wireless link, i.e., RLC PDUs are not necessarily sent in same order (excluding re-transmissions) over second link as over first wireless link. The RLC in the client node 17a/PBS 13a terminates status reports received from the WT 11a. When status report from the WT 11a indicate missing RLC PDUs, then the RLC in the client node 17a/PBS 13a triggers a re-transmission of those RLC PDUs it has already received from the RLC in the HUB (i.e., of those RLC PDUs that transmission failed over the second wireless link).

In some embodiments where the RLC entity in the client node 17a/PBS 13a does not terminate the RLC protocol the same sequence numbers are used over the first wireless link and the second wireless link. Then the sending RLC in the hub node 16a may adjust the RLC PDU size to be suitable for both wireless links. Signaling from the client node 17a/PBS 13a about quality of the second wireless link may be needed in order to achieve good performance. Alternatively, the sending RLC entity in the client node 17a/PBS 13a for the second wireless link adjusts the size by using re-segmentation of RLC PDUs.

In some embodiments where the RLC in the client node 17a/PBS 13a does terminate the RLC protocol, the receiving RLC entity detects that an unknown number of SDUs are missing. The receiving RLC entity then notifies the sending RLC entity (of the second wireless link) that an unknown number SDUs are missing and/or delayed. That the number of SDUs that are missing/delay is unknown is not an issue; the sending RLC entity (of the second wireless link) just allocates at least one RLC sequence number (as in previous embodiments, see above) to be used for the RLC PDU that later will contain the missing/delayed SDUs.

An illustrative, non-limiting, example based on at least some of the herein disclosed embodiments will now be described. In general terms, the illustrative example describes enhanced RLC behavior when the hub node 16a, client node 17a, and PBS 13a support such enhanced RLC behavior. The example is based on the assumption that is some RLC segments are not delivered to the client node 17a from the hub node 16a, for example, awaiting HARQ re-transmission, but some future RLC segments are delivered. In FIG. 10, which schematically illustrates enhanced RLC behavior, this is exemplified by the segments with sequence numbers 4 and 5 which are not delivered correctly to the client node 17a RLC.

The enhanced RLC/PDCP in the client node 17a will in this situation not stop delivering data to the PBS 13a RLC awaiting the retransmissions of the missing RLC SDUs. Instead the data in the delivered RLC SDUs are used to estimate the missing data in the missing RLC SDUs. In the present illustrative, non-limiting, example the data for one WT 11a associated with the GTP-U instance with TEID X is used to schematically describe the behavior. In the GTP header the sequence number for the GTP tunnel is used to detect the missing segments, SN M+1 . . . M+6 in the example. The amount of missing GTP-U sequence numbers is then used to estimate the amount of missing data. In the PBS 13a one or more placeholder RLC SDUs are generated in the PBS 13a PDCP/RLC instance associated to TEID X, thus enabling estimation of how many RLC PDUs are needed to transmit the missing SDUs. This is exemplified by RLC PDU denoted D5 in FIG. 10.

As disclosed above, the placeholder PDU(s) may serve two functions. Firstly, they may act as placeholders for the data (SDUs). Secondly, they may provide updated RLC sequence numbers for the RLC PDUs (in the present illustrative, non-limiting, example RLC PDUs 6 and 7) that, in the enhanced RLC/PDCP implementation, may be used to transmit the data that is received before the retransmission of the missing RLC SDUs from the hub node 16a is received in the client node 17a.

After that the missing data is received by the PBS 13a and actual RLC PDUs (in the present illustrative, non-limiting, example RLC PDU 5) are generated (or possibly a different number of RLC PDUs using RLC re-segmentation, see above). When this data is received in the WT 11a RLC (a legacy RLC receiver) the RLC reordering function then buffers the pre-sent SDUs (in the present illustrative, non-limiting, example RLC PDUs 6 and 7) and delivers the data in order to the Higher layers in the WT 11a when the delayed segments are received (in the present illustrative, non-limiting, example RLC PDU 5).

In summary, according to at least some of the herein disclosed embodiments, for two wireless links connected in series and implementing, for example, RLC/PDCP, a receiving device, such as a client node, of the first wireless link detects missing data and informs the transmitting device, such as a radio base station, of the second wireless link about the missing data. The transmitter of the second wireless link uses the information about the missing data to, for example, pre-assign sequence numbers to the missing data. The transmitter of the second wireless link transmits, for example, RLC/PDCP PDUs for received data with the updated sequence numbers. The transmitter of the second wireless link transmits the missing data when it arrives using the pre-assigned sequence numbers.

Thus, according to at least some of the herein disclosed embodiments, for a sequence of RLC instances at least some of the herein disclosed embodiments enable in-sequence delivery over the total sequence of RLC instances without requiring in-sequence delivery for each RLC instance when the carried data includes sequence numbers, such as GTP-U. This solves issues of having under-utilized wireless links 18, 19 as the sending and receiving network entities, such as client nodes 17a and PBS 13a may transmit already received data as the data is not forced to be transmitted in sequence over the radio interface. This may be enabled by detecting delayed data and reserving RLC sequence numbers for this data so that the sequence numbers can be used for the data when it arrives.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for packet handling in a client node between a hub node and a radio base station in a wireless network, the method being performed by the client node, comprising the steps of:
wirelessly receiving packets from a hub node, the packets being received in an order and being associated with an in-sequence order;
detecting that at least one packet of said packets is received out of said in-sequence order, and in response thereto providing an indicator indicating the in-sequence order; and
providing said packets and said indicator to a radio base station.

2. The method according to claim 1, wherein said packets are provided to the radio base station in the order said packets were received from the hub node.

3. The method according to claim 1, wherein the indicator is a sequence number, and wherein one sequence number is provided in each packet.

4. The method according to claim 3, wherein detecting that said at least one of said packets is received out of said in-sequence order is based on detecting a missing sequence number in said received packets.

5. The method according to claim 1, wherein providing said indicator indicating the in-sequence order comprises:
reserving one sequence number for each at least one packet received out of said in-sequence order; and
providing said one sequence number to said at least one packet upon its reception.

6. The method according to claim 1, wherein the packets are received and/or provided using a re-transmission protocol using sequence numbers.

7. The method according to claim 1, wherein the packets from the hub node are wirelessly received in a radio link control, RLC, instance.

8. The method according to claim 1, wherein said at least one packet being received out of said in-sequence order is detected at a packet data convergence protocol, PDCP, peer level.

9. (canceled)

10. The method according to claim 1, wherein each packet is a protocol data unit, PDU, each PDU comprising at least one service data unit, SDU.

11. A method for packet handling in a radio base station between a client node and a wireless terminal device in a wireless network, the method being performed by the radio base station, comprising the steps of:
receiving packets and an indicator from a client node, the packets being received in an order and being associated with an in-sequence order as indicated by said indicator;
detecting that at least one of said packets is received out of said in-sequence order based on said indicator, and in response thereto providing a further indicator enabling restoration of the in-sequence order; and
wirelessly transmitting said packets and said further indicator to a wireless terminal device.

12. The method according to claim 11, wherein said packets are transmitted to the wireless terminal device in the order said packets were received from the client node.

13. The method according to claim 11, wherein the indicator is a sequence number, and wherein one sequence number is provided in each received packet.

14. The method according to claim 11, wherein the further indicator is provided by:
generating at least one placeholder packet representing said at least one packet received out of said in-sequence order;
generating a placeholder transmission of said at least one placeholder packet; the method further comprising:
wirelessly transmitting said at least one packet received out of said in-sequence order once received by the radio base station, and in response thereto marking said at least one placeholder packet as transmitted.

15. The method according to claim 11, wherein the further indicator is provided as at least one sequence number reservation.

16. The method according to claim 14, further comprising:
determining a size of said at least one placeholder packet based on at least one of a historic average of previously received packets, a maximum allowable packet size, and information received from the client node.

17. The method according to claim 14, further comprising:
receiving a notification from the client node about said at least one packet being received out of said in-sequence order and generating said at least one placeholder packet in response thereto.

18. The method according to claim 11, wherein the packets are received and/or transmitted using a re-transmission protocol using sequence numbers.

19. The method according to claim 18, wherein detecting that said at least one of said packets is received out of said in-sequence order is based on detecting a missing sequence number in said received packets.

20. (canceled)

21. The method according to claim 11, wherein said at least one packet being received out of said in-sequence order is detected at a packet data convergence protocol, PDCP, peer level.

22. The method according to claim 11, wherein said at least one packet being received out of said in-sequence order is detected at a radio link control, RLC, protocol, peer level.

23. (canceled)

24. The method according to claim 11, wherein each packet is a protocol data unit, PDU, each PDU comprising at least one service data unit, SDU and wherein each received PDU comprises different number of SDUs than each transmitted PDU.

25. A client node for packet handling in a client node between a hub node and a radio base station in a wireless network, the client node comprising:
a communications interface configured to wirelessly receive packets from a hub node, the packets being received in an order and being associated with an in-sequence order;
a processor configured to detect that at least one packet of said packets is received out of said in-sequence order, and in response thereto providing an indicator indicating the in-sequence order; and
wherein the communications interface is further configured to provide said packets and said indicator to a radio base station.

26. A radio base station for packet handling in a radio base station between a client node and a wireless terminal device in a wireless network, the radio base station comprising:
a communications interface configured to receive packets and an indicator from a client node, the packets being received in an order and being associated with an in-sequence order as indicated by said indicator;
a processor configured to detect that at least one of said packets is received out of said in-sequence order based on said indicator, and in response thereto providing a further indicator enabling restoration of the in-sequence order; and
wherein the communications interface is further configured to wirelessly transmit said packets and said further indicator to a wireless terminal device.

27. (canceled)

28. (canceled)

29. (canceled)
